(19) United States
(12) Patent Application Publication
(10) Pub. No.: US 2011/0055676 A1
(43) Pub. Date: Mar. 3, 2011

(54) Interactive user interface by embedding a document into a standardized object container

(76) Inventors: Xingzhong Sun, Collegeville, PA (US); Eugene Resnick, Cherry Hill, NJ (US); Andre Downey, Philadelphia, PA (US); Laurie Dieffenbach, Chesterbrook, PA (US)

(21) Appl. No.: 12/583,945

(22) Filed: Aug. 28, 2009

(51) Int. Cl. G06F 17/00; G06F 3/048

(52) U.S. Cl. 715/201; 715/781

(57) ABSTRACT

A user interface is provided for a computer application program having a document and one or more interactive tools associated with the document. The document and associated tools are embedded into a standardized object container. The standardized object container is embedded into a computer display program capable of displaying instances of the standardized object container. Interactions between the tools and the document are processed by the computer application program. The application program and display program collaborate to handle user interface events according to a protocol determined by the standardized object container. A first advantage of this approach is that the tools do not need to have separate versions developed for each display file type of interest. A second advantage of this approach is that interactions between the tools and the document are handled by the computer application program, which provides enhanced flexibility and capability.

### FIELD OF THE INVENTION

This invention relates to providing a user interface for a computer program.

### BACKGROUND

Reusable software components are of general interest in software engineering because component re-use can advantageously reduce development time and cost. Standardized frameworks for reusable software components have been introduced, and some are in wide use. For example, one such framework is known as ActiveX® (a trademark of Microsoft Inc.). Reusable software components in this framework are known as ActiveX® controls. These controls perform a particular function or set of functions in Microsoft Windows® in a way that is independent of the programming language used to implement them. A software application can then be composed from one or more of these components in order to provide its functionality.

Although ActiveX® controls provide significant advantages for software development, there remain situations in which efficient re-use of software components is difficult. One such situation relates to interactive under interfaces, where one or more tools are associated with a document. It is often desirable to display the tools as docking windows associated with the document window. It is also often desirable to display a document and associated docking windows in several different ways (e.g., with an internet browser, or with a document editing application). However, with conventional approaches, an ActiveX® control for displaying a docking window in an internet browser cannot readily be re-used to provide the same functionality in a document editing application. In other words, custom coding for each kind of display file of interest is often required, which is a tedious and time-consuming process.

Accordingly, it would be an advance in the art to provide for more efficient re-use of software components, especially in connection with user interfaces.

### SUMMARY

A user interface is provided for a computer application program having a document and one or more interactive tools associated with the document. The document and associated tools are embedded into a standardized object container. Suitable standardized object containers are presently in wide use in the art. For example, Microsoft® Object Linking and Embedding (OLE) technology provides such standardized object containers.

The standardized object container is embedded into a computer display program capable of displaying instances of the standardized object container. Suitable display programs are also presently in wide use in the art, and include internet browsers, document editors, etc.

Interactions between the tools and the document are processed by the computer application program. The application program and display program collaborate to handle user interface events according to a protocol determined by the standardized object container.

This approach provides several significant advantages. First, the tools (which can be ActiveX® controls) do not need to have separate versions developed for each display file type of interest. Instead, the embedding of the tools into the standardized container, followed by embedding the standardized container into a display program renders development of the tools independent of the detailed nature of the final display program (e.g., internet browser, document editor, etc.).

A second advantage of this approach is that interactions between the tools and the document (or between one document and another if multiple documents are open) are handled by the computer application program. This provides much greater flexibility and capability compared to an alternate approach where tool functionality is provided by the display program.

### BRIEF DESCRIPTION OF THE DRAWINGS

FIG. 1 shows an architecture relating to a first embodiment of the invention.

FIG. 2 shows an architecture relating to a second and preferred embodiment of the invention.

FIG. 3 shows an exemplary screen display relating to an embodiment of the invention.

### DETAILED DESCRIPTION

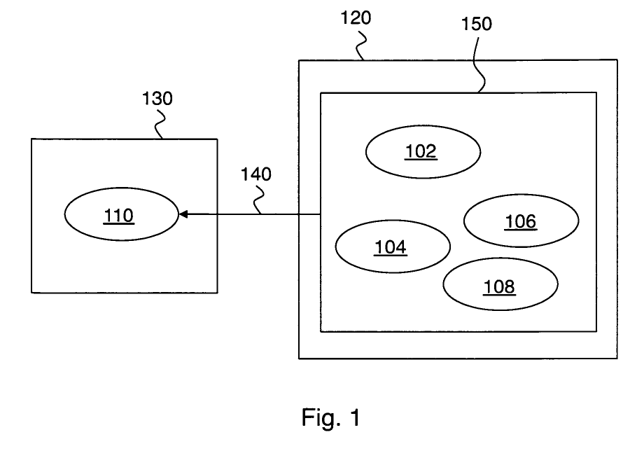

FIG. 1 shows an architecture relating to a first embodiment of the invention. In this example, a computer application program 120 has a document 102 and associated tools 104, 106, 108. Three tools are shown in this example, but any number of tools can be employed in practicing the invention. Application program 120 processes interactions between document 102 and the tools (104, 106, and 108). In a preferred embodiment, the tools are reusable software components, such as ActiveX® controls. The tools can be provided as part of the application program and/or they can be custom coded by an end user. Any custom coded tools will be compatible with the present user interface approach, provided the user-defined tool is in compliance with the requirements for embedding as herein described.

It is important to note that user-defined tools in the present approach do not require users to custom-code basic window management functions (e.g., open window, close window, move window, resize window). Instead, this basic functionality can provided by library software that relies on the embedding interface. Making the development of custom tools easier in this manner is another significant advantage of the present invention.

Document 102 and its associated tools (i.e., 104, 106, and 108) are preferably included in a frame window 150. More specifically, frame window 150 is a parent window of the document and tools. Thus, document 102 and tools 104, 106, and 108 are child windows of frame window 150. Frame window 150 is embedded (140) into a standardized object container 110, which in turn is embedded into display program 130. Suitable standardized object containers are presently in wide use in the art. For example, Microsoft® Object Linking and Embedding (OLE) technology provides such standardized object containers. In a preferred embodiment, standardized object container 110 is an OLE-compliant ActiveX® control. More generally, 110 can be any standardized container capable of accepting the embedding of frame window 150 and capable of being embedded into display program 130.

Here “standardized object container” means a container interface having an embedding capability that is in widespread use in the art and that has a well defined meaning to skilled art workers (e.g., Object Linking and Embedding, circa 2009). The main significance of the use of standardized object containers is that library software capable of interfacing with such containers is readily available, which can significantly reduce the development time of the present approach.

Display program 130 can be any program capable of displaying instances of the standardized object container (e.g., an internet browser, document viewer/editor, spreadsheet, interactive form, etc.).

Interactions between document 102 and tools 104, 106, and 108 are processed by computer application program 120. Application program 120 and display program 130 collaborate to handle user interface events according to a protocol determined by standardized object container 110. User interface events can be received directly by application program 120 and/or they can be received by display program 130 which passes the received user interface events to the application program.

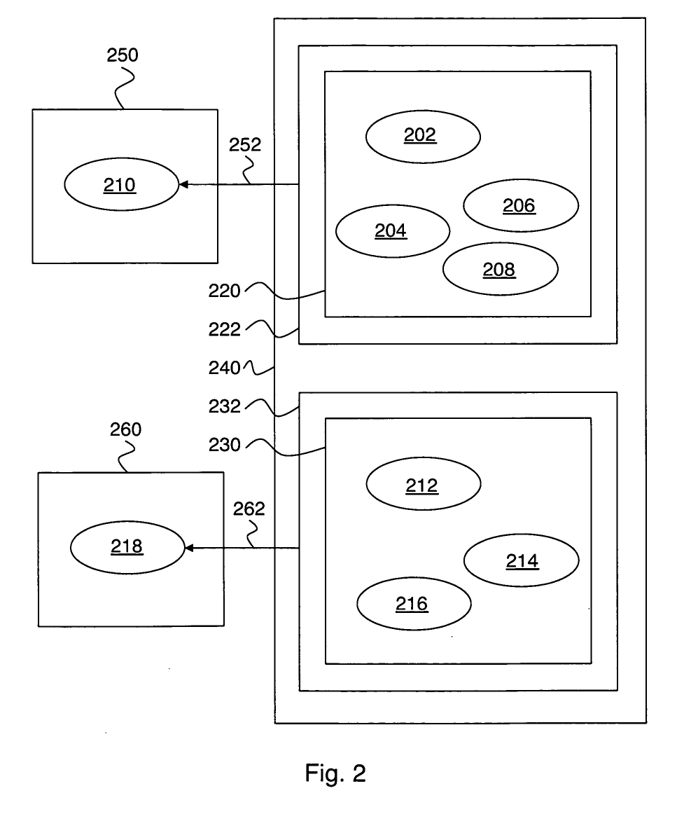

FIG. 2 shows an architecture relating to a second and preferred embodiment of the invention. In this example, computer application program 240 has document 202 and document 212, each document having associated tools. Tools 204, 206, and 208 are associated with document 202, and tools 214, and 216 are associated with document 212. Document 202 and its tools 204, 206, and 208 are child windows of a corresponding docking frame 220. Similarly, document 212 and its tools 214 and 216 are child windows of a corresponding docking frame 230. The purpose of docking window frames 220 and 230 is to provide for display of the associated tools as docking windows within a larger document viewing window. Docking window frames 220 and 230 can be implemented using commercial development software (e.g., the Stingray® Objective Toolkit).

Docking frames 220 and 230 are child windows of frame windows 222 and 232, respectively. Frame window 222 is embedded (252) in standardized object container 210, which in turn is embedded into display program 250. Similarly, frame window 232 is embedded (262) in standardized object container 218, which in turn is embedded into display program 260. The principles of these embeddings are as described above in connection with FIG. 1.

The main difference between the example of FIG. 2 and the example of FIG. 1 is the use of docking frames 220 and 230 inside of frame windows 222 and 232. As indicated above, docking frames 220 and 230 provide for the display of the tools as docking windows, which is often a preferred user interface approach. Although it is possible, in principle, for a single level of windowing to provide the two functions of 1) providing docking window capability and 2) providing a suitable interface for embedding, such an approach would require considerable custom software development effort to provide such windows. In contrast, the approach of FIG. 2 provide this functionality efficiently by making use of readily available software components. For example, the docking frames can be implemented using commercial development software as indicated above, and frame windows 222 and 232 can be implemented as standard MFC (Microsoft Foundation Class) derivatives (e.g., as MFC InPlace frames). In this approach, docking frames 220 and 230 provide a docking window capability, and frame windows 222 and 232 provide an embeddable interface. In the example of FIG. 2, the embedding of the documents and tools into the corresponding standardized object containers is facilitated by the use of the indicated window hierarchy.

Another difference between the examples of FIGS. 1 and 2 is that two documents are shown on FIG. 2. Any number of documents can be open simultaneously when practicing embodiments of the invention. In cases where two or more documents are open, any interactions between the documents are handled by the application program.

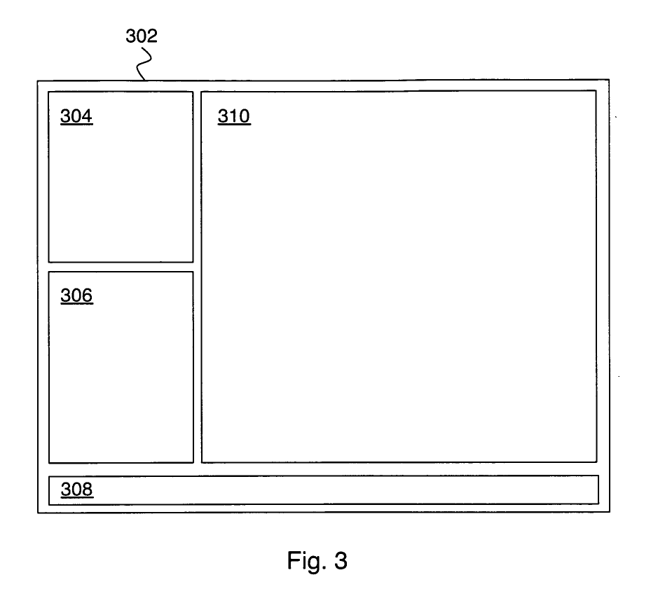

FIG. 3 shows an exemplary screen display 302 relating to an embodiment of the invention. Here, 310 is a document display area, and 304, 306, and 308 show locations for tool docking windows. As indicated above, user interface events are handled by collaboration between the application program and the display program. However, it is important to note that the application program handles the interaction between document and tools (and/or between documents, if two or more documents are open). This provides a great deal of flexibility as compared to approaches where the tools are provided by the display program.

For example, the application program could be a read-only viewer for industrial process control, implemented as an OLE server application, and document area 310 can show a diagram of part or all of an industrial process. In this example, the tools can include functions such as providing numerical details (e.g., data tables, statistics, metadata, etc.) relating to items displayed in area 310, providing a playback controller, and providing an element display (e.g., if the document shows one well of a well field, the element display can provide a list of other wells in the same well field). Selecting one of the other wells in this list (e.g., with a pointer click) can cause the display to be updated to show the selected well. The computer application program makes any needed changes to the display and/or retrieves data as needed in response to user input via the tools.

If the tools were provided as part of the display program, it would be difficult or impossible for the tools to interact with the displayed information as in the preceding example. Thus, this enhanced capability of the tools is another significant advantage of the present approach.

Practice of the invention is compatible with various user interface design options, such as whether or not to provide for auto-hide of the docking windows, and whether or not to provide for placement of a docking window anywhere within the window of the standardized object container. Embodiments of the invention have been implemented using Microsoft® Visual C++ 2008, but any other language and/or development environment can also be used to practice the invention according to the above-described principles.

1. A computer implemented method for providing an interactive user interface, the method comprising:
providing a computer application program having a document and one or more interactive tools;
embedding said document and said tools into a standardized object container; and
embedding said standardized object container into a computer display program capable of displaying instances of said standardized object container;
wherein interactions between said tools and said document are processed by said computer application program; and
wherein said application program and said display program collaborate to handle user interface events according to a protocol determined by said standardized object container.

2. The method of claim 1,
wherein said document and said tools are child windows of a frame window; and
wherein said frame window is embedded in said standardized object container.

3. The method of claim 1,
wherein said document and said tools are child windows of a docking frame that provides for the display of said tools as docking windows;
wherein said docking frame is a child window of a frame window; and
wherein said frame window is embedded in said standardized object container.

4. The method of claim 1, wherein said standardized object container is an Object Linking and Embedding (OLE) container.

5. The method of claim 4, wherein said standardized object container is embedded into a reusable software component.

6. The method of claim 1, wherein said one or more interactive tools are reusable software components.

7. The method of claim 1, wherein said user interface events can be received directly by said application program.

8. The method of claim 1, wherein said user interface events can be received by said display program which passes said received user interface events to said application program.

9. A computer implemented method for providing an interactive user interface, the method comprising:
providing a computer application program having two or more documents, each document having a corresponding set of interactive tools;
embedding each said document and corresponding tools into a corresponding standardized object container; and
embedding said standardized object containers into a computer display program capable of displaying instances of said standardized object container;
wherein interactions between said tools and said documents are processed by said computer application program;
wherein interactions between one of said documents and another of said documents are processed by said computer application program; and
wherein said application program and said display program collaborate to handle user interface events according to a protocol determined by said standardized object container.

10. The method of claim 9,
wherein each said document and corresponding tools are child windows of a corresponding frame window; and
wherein said frame windows are embedded in said corresponding standardized object containers.

11. The method of claim 9,
wherein each said document and corresponding tools are child windows of a corresponding docking frame that provides for the display of said tools as docking windows;
wherein each said docking frame is a child window of a corresponding frame window; and
wherein each said frame window is embedded in said corresponding standardized object container.

12. The method of claim 9, wherein said standardized object containers are Object Linking and Embedding (OLE) containers.

13. The method of claim 12, wherein said standardized object containers are embedded into reusable software components.

14. The method of claim 9, wherein member tools of said sets of interactive tools are reusable software components.

15. The method of claim 9, wherein said user interface events can be received directly by said application program.

16. The method of claim 9, wherein said user interface events can be received by said display program which passes said received user interface events to said application program.
